(19) United States
(12) Patent Application Publication
(10) Pub. No.: US 2008/0208980 A1
(43) Pub. Date: Aug. 28, 2008

(54) EMAIL AGGREGATION SYSTEM WITH SUPPLEMENTAL PROCESSING INFORMATION ADDITION/REMOVAL AND RELATED METHODS

(76) Inventors: Michael Ruarri Champan, Waterloo (CA); Amgad Waniss, Waterloo (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/678,754

(22) Filed: Feb. 26, 2007

(51) Int. Cl. G06F 15/16

(52) U.S. Cl. 709/206

(57) ABSTRACT

An electronic mail (email) system may include a plurality of mobile wireless communications devices, a plurality of email storage servers, and an email aggregation system operatively connected between the plurality of mobile wireless communications devices and the plurality of email storage servers for directing emails therebetween. The email aggregation system may include an inbound gateway server for receiving inbound emails and selectively adding supplemental processing data thereto, as well as at least one mail user agent (MUA) server downstream from the input gateway server for processing received emails based upon the selectively added supplemental processing data. The email aggregation system may further include an outbound gateway server downstream from the at least one MUA server for sending outbound emails after removing the supplemental processing data therefrom.

### FIELD OF THE INVENTION

The present invention relates to the field of communications systems, and, more particularly, to electronic mail (email) communications systems and related methods.

### BACKGROUND OF THE INVENTION

Email has become an integral part of business and personal communications. As such, many users have multiple email accounts for work and home use. Moreover, with the increased availability of mobile cellular and wireless local area network (LAN) devices that can send and receive emails, many users wirelessly access emails stored in source mailboxes of different email storage servers (e.g., corporate email storage server, Gmail, Yahoo, Hotmail, AOL, etc.).

Mail user agents (MUAs) are applications which use a technique called polling to relay messages from the mail server to the mail program at a user's computer or mobile wireless communications device. An MUA is a program running either on a user's personal computing device (mobile or stationary), or on a shared email relay server that checks for new mail on behalf of a multitude of such users. More particularly, polling is the retrieval of incoming messages from other users at the mail server and delivery of these messages to the user's mailbox.

An email relay server may be particularly appropriate where emails need to be relayed to wireless communications devices. This is because having a wireless communications device, such as a cellular device, polling an email server(s) via a cellular network may result in increased usage charges for users as well as consumption of network resources. Thus, some email systems use an email relay server that checks one or more electronic user mailboxes for a given user, and provides a notification message to the user's wireless communications device when a new email message(s) is available. The wireless communications device then polls the email relay server for the new email message(s), which therefore reduces the amount of wireless communications resources consumed by the device. The email relay server may also relay emails generated by user devices to the appropriate email storage servers.

One significant problem with email communications is dealing with the high volume of undesirable “spam” emails that can consume significant amounts of email system storage and bandwidth resources. Various approaches have been developed for alleviating the burden of spam emails at the local network level. One such system is the C-series email security appliances from IronPort Systems, Inc. of San Bruno, Calif. The IronPort® system provides spam defense by providing two layers of protection, namely a preventive layer of reputation filters, followed by reactive filters. The reputation filters provide an outer layer of defense using IronPort® SenderBase® data to perform a real-time email traffic threat assessment and identify suspicious email senders. The IronPort® anti-spam system utilizes threat detection based on IronPort's Context Adaptive Scanning Engine™ (CASE). IronPort's CASE examines the complete context of a message, including: “What” content the message contains; “How” the message is constructed; “Who” is sending the message; and “Where” the call to action of the message takes you.

Despite the advancements provided by such systems, further techniques for efficiently handling emails on a large scale, particularly with respect to spam management, may be desirable in certain applications. This may particularly be the case for email relay servers and MUAs, for example.

### BRIEF DESCRIPTION OF THE DRAWINGS

FIG. 1 is a schematic block diagram of an email system in accordance with one embodiment providing supplemental processing data addition and removal to email messages before and after processing by a mail user agent, respectively.

FIGS. 2 through 7 are flow diagrams illustrating various email aggregation method aspects.

FIG. 8 is a schematic block diagram of an exemplary embodiment of the system of FIG. 1.

FIG. 9 is a schematic block diagram illustrating exemplary components of a mobile wireless communications device for use with the present invention.

### DETAILED DESCRIPTION OF THE PREFERRED EMBODIMENTS

The present description is made with reference to the accompanying drawings, in which preferred embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in different embodiments.

Generally speaking, an electronic mail (email) system is disclosed herein which may include a plurality of mobile wireless communications devices, a plurality of email storage servers, and an email aggregation system operatively connected between the plurality of mobile wireless communications devices and the plurality of email storage servers for directing emails therebetween. More particularly, the email aggregation system may include an inbound gateway server for receiving inbound emails and selectively adding supplemental processing data thereto, as well as at least one mail user agent (MUA) server downstream from the input gateway server for processing received emails based upon the selectively added supplemental processing data. The email aggregation system may further include an outbound gateway server downstream from the at least one MUA server for sending outbound emails after removing the supplemental processing data therefrom.

By way of example, the supplemental processing data may comprise spam sensitivity data. This advantageously allows the processor to prevent delivery or take other appropriate action for emails that have a high likelihood of being spam as indicated by the spam sensitivity data. In accordance with another advantageous aspect, the at least one MUA server may include a plurality thereof. As such, the supplemental processing data may comprise supplemental routing data for routing emails to different MUA servers. By way of example, each MUA server may have a respective IP address associated therewith. Thus, the supplemental routing data may comprise an Internet Protocol (IP) address associated with a desired MUA server.

In addition, the supplemental processing data may comprise mail exchange (MX) record data. Such data may be used to provide various information regarding the source and/or destination of a given email, for example, that may be used to more efficiently process various emails, for example. In particular, the supplemental processing data may comprise email storage server identification data. Thus, if a given email storage server is unavailable for email retrieval and/or delivery, the at least one MUA could advantageously postpone processing emails that would require access to the given email storage server until a later time, while still processing emails that do not require access to the given email storage server.

In accordance with another advantageous aspect, the supplemental processing data may comprise test indicator data for causing the MUA server(s) to perform one or more test operations. Additionally, the supplemental processing data may comprise viral vector data. Thus, similar to spam sensitivity data, the viral vector data may be used to indicate emails potentially infected with viruses so that they can be properly quarantined, deleted, etc.

The wireless communications devices may be cellular communications devices, for example. As such, the outbound gateway server may accordingly send emails to the wireless communications devices via a cellular communications network. An email aggregation system, such as the one described briefly above, is also provided.

A related email aggregation method aspect may be for directing emails between a plurality of mobile cellular communications devices and a plurality of email storage servers. The method may include receiving and selectively adding supplemental processing data to inbound emails at an inbound gateway server, and processing received emails at least one mail user agent (MUA) server downstream from the input gateway server based upon the selectively added supplemental processing data. The method may further include removing the supplemental processing data from the processed received emails at an outbound gateway server downstream from the at least one MUA server prior to sending.

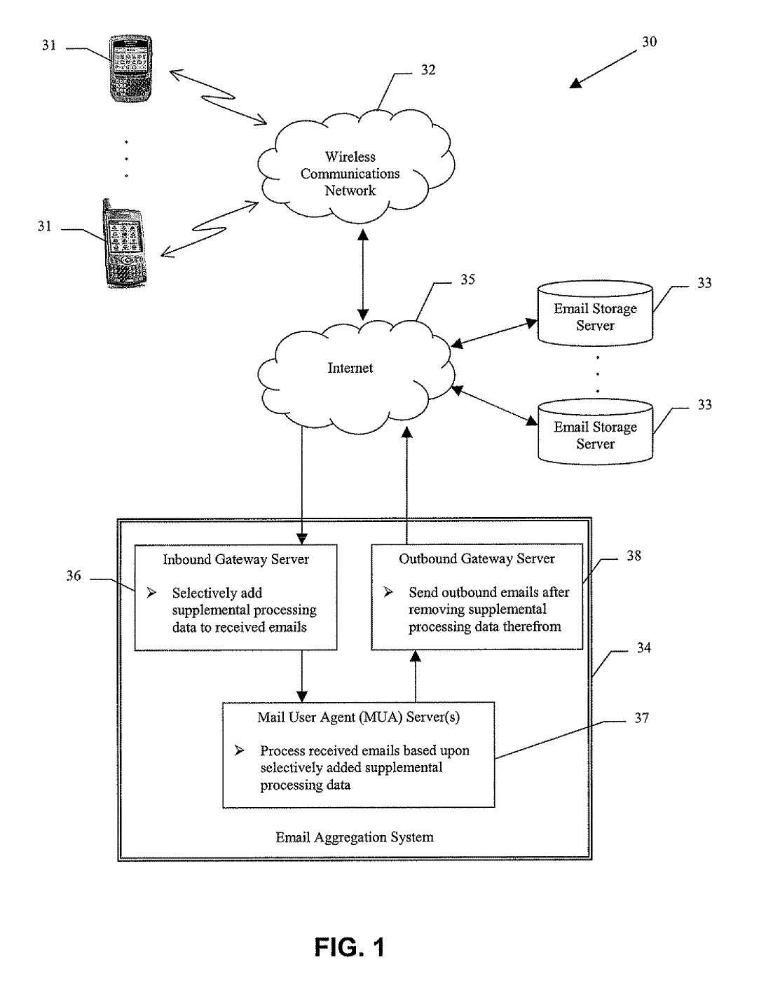

Referring initially to FIG. 1, an email system 30 illustratively includes a plurality of mobile wireless communications devices 31. By way of example, the mobile wireless communications devices 31 may be cellular devices, such as cellular “smart phones” that are capable of sending and receiving emails via a wireless (e.g., cellular) communications network 32. However, it should be noted that in some embodiments the mobile wireless communications devices may communicate via other types of wireless networks, such as wireless local area networks (WLANs), for example, instead of or in addition to cellular networks, as will be appreciated by those skilled in the art.

The system 30 also illustratively includes a plurality of email storage servers 33. As noted above, such email storage servers are typically provided or hosted by Internet service providers (e.g., Google, Yahoo, AOL, Hotmail, etc.), as well as corporations. As will be readily appreciated by the skilled artisan, accounts are established for users of the various email systems such that emails can be sent to and from the given account via standardized email protocols, such as POP3 and SMTP, for example. Of course, other protocols may also be used, as will be discussed further below.

In addition, the system 30 further illustratively includes an email aggregation system 34 that is operatively connected between the plurality of mobile wireless communications devices 31 and the plurality of email storage servers 33 for directing emails therebetween. More particularly, the email aggregation system is illustratively connected between the devices 31 and server 33 via the Internet 35.

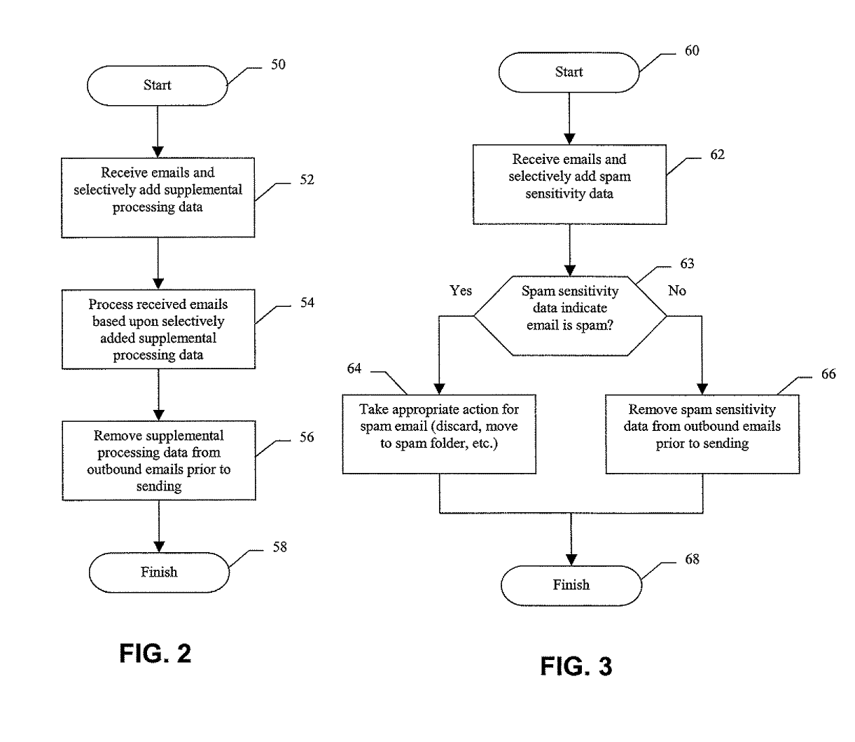

Referring additionally to FIG. 2, operational method aspects of the email aggregation system 34 are now generally described beginning at Block 50. The email aggregation system 34 illustratively includes one or more inbound gateway servers 36 for receiving inbound emails and advantageously selectively adding supplemental processing data to the email messages, at Block 52. More particularly, the supplemental processing data is data that is not otherwise included in the original email received from the email server 33 or wireless communications device 31. By way of example, the supplemental processing data may take the form of one or more additional email message headers that are attached to the email before being passed downstream for further processing, although the supplemental processing may take other appropriate forms in different embodiments, as will be appreciated by those skilled in the art.

In this regard, one or more mail user agent (MUA) servers 37 are illustratively downstream from the input gateway server 36 for processing received emails based upon the selectively added supplemental processing data, at Block 54. Generally speaking, the typical processing operations that may be performed by the MUA server(s) 37 in the ordinary course or routing emails may include associating emails with respective user accounts so that the appropriate routing information can be determined. For example, if the email is to be forwarded to a user's handheld device 31, then the MUA server 37 may need to determine a device identifier (e.g., PIN, IMEI, etc.), wireless communications carrier, etc., so that the email can be routed to the appropriate user device. Moreover, the MUA server 37 may also need to track user charges so the user can be billed accordingly for email system services, or be prevented from exceeding allotted usage limits, for example. Furthermore, the MUA may also have to track email storage server information, such as domain name server (DNS) and/or mail exchange (MX) records, as well as user login/password information, to deliver and/or retrieve emails thereto or therefrom, as will be appreciated by those skilled in the art.

In addition to the basic or typical operations required for email aggregation, it may also be desirable to perform supplemental operations by taking advantage of the supplemental processing data that can be added on the front-end by the inbound gateway server 36. Various types of supplemental processing data and respective processing operations that may be performed by the MUA server 37 based thereon will be discussed in detail below. Generally speaking, however, the supplemental processing data provides instructions or routing data that are intended for internal use within the email aggregation system 34 in email handling/processing operations, but are not necessarily intended to be forwarded outside of the email aggregation system. To this end, the email aggregation system 34 also illustratively includes an outbound gateway server downstream from the MUA server(s) 38 for sending outbound emails after removing the supplemental processing data therefrom, at Block 56, thus concluding the illustrated method (Block 58).

Turning now additionally to FIG. 3, beginning at Block 60, one example of supplemental processing data that may be selectively added to received emails may be spam sensitivity data, at Block 62. Generally speaking, if the spam sensitivity data indicates to the MUA server 37 that an email is spam (or has a high likelihood of being spam), then the MUA can prevent delivery or take other appropriate action for such emails, at Block 64. Otherwise, the spam sensitivity data is removed from outbound emails prior to sending as discussed above, at Block 66, thus concluding the illustrated method (Block 68).

More specifically, the spam sensitivity data may be used for assigning a spam “score” (i.e., a likelihood level of being spam) to email messages based on Internet Protocol (IP) address reputation. As will be appreciated by those skilled in the art, email messages are associated with a sender IP address. A reputation-based scoring system therefore advantageously assesses the relative reputation of IP addresses that are associated with email messages. The MUA server(s) 37 may advantageously perform this assessment in substantially real-time, and constantly rescore the reputation of the IP address. The IP address that is associated with a given email address is assessed using a pool of criteria to determine its spam sensitivity level or score. These criteria may include, for example: adherence to correct IP address and Domain Name System (DNS) conventions; total volume of email messages from the IP address over a given period of time; change in volume relative to a given period of time; reports of spam messages from that IP address; and the ability for the IP address to accept email messages correctly

In accordance with one exemplary embodiment, the inbound gateway server 36 assigns each IP address a score based on a logarithmic type scale that ranges from 10 for a reputable sender, to −10 for a known spam message sender, although other scales may also be used. The MUA server(s) 37 uses this information to decide the likelihood of an email message being legitimate without examining the content. If the MUA server(s) 37 determines the email message is a spam message, it may then reject the email delivery attempt before it gets to the outbound gateway server 38.

The reputation scoring system may advantageously provide the following features: reduces the need for system administrators to manage complex language dictionaries or to update definition files with new spam email messages; does not evaluate email message content; identifies spam messages by evaluating IP addresses, which are extremely difficult for a spam message sender to falsify; provides substantially immediate response to patterns seen on the Internet; uses many data points to assess IP addresses which reduces the risk of bad or false entries; and uses historical data for more accurate scoring based on trends.

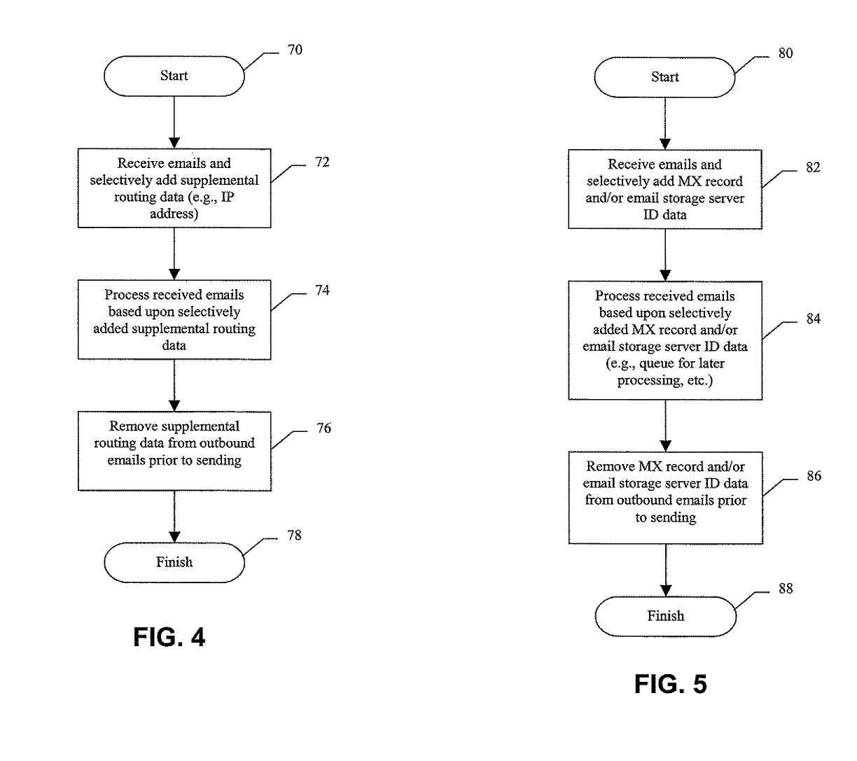

Another potentially advantageous use for the supplemental processing data is to provide supplemental routing data or information, as will be described now with reference to FIG. 4 and beginning at Block 70. More particularly, in relatively large scale embodiments where a plurality of MUA servers 37 are used to handle a large volume of emails, supplemental routing data may be added for routing emails to different MUA servers, at Block 72. This could be done for load balancing purposes, to group emails by respective user accounts or wireless network providers, etc. Typically, each MUA server 37 within the email aggregation system 34 will have a unique identifier associated therewith, such as an IP address, as will be appreciated by those skilled in the art. Thus, the inbound gateway server 36 can selectively add the appropriate IP address of the given MUA server 37 that is to process a given email. The MUA servers 37 would then process for sending only those emails that have its respective IP address added thereto, at Block 74, followed by removal of the supplemental routing data (e.g., MUA server IP address) at Block 76, to conclude the illustrated method (Block 78).

In accordance with a related aspect now described with reference to FIG. 5 and beginning at Block 80, the supplemental processing data may comprise mail exchange (MX) record data or an identifier of a given email storage server 33 (IP address, etc.), at Block 82. Having such data identifying the source and/or destination of a given email, for example, may be used to more efficiently process emails, at Block 84. For example, if a given email storage server 33 is unavailable for email retrieval and/or delivery, the MUA server 37 could advantageously postpone or queue processing of emails that would require access to the given email storage server until a later time, while still processing emails that do not require access to the given email storage server. The MX record and/or email server identification data is subsequently removed prior to sending, at Block 86, as discussed above, which concludes the illustrated method (Block 88).

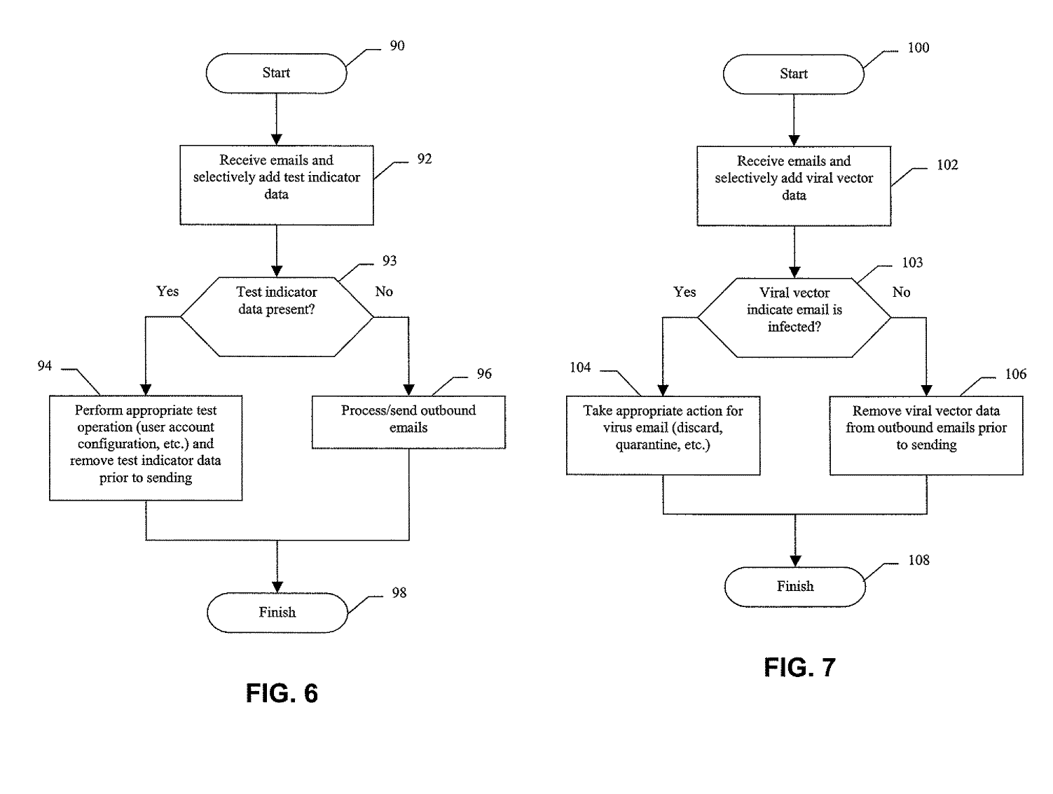

In accordance with another advantageous aspect now described with reference to FIG. 6 and beginning at Block 90, the supplemental processing data may comprise test indicator data for causing the at least one MUA server to perform one or more test operations, at Block 92. Thus, for example, when the inbound gateway server 36 adds a test indicator, at Block 93, the MUA server 37 advantageously performs a designated test operation(s) upon recognizing this data added to the email, at Block 94. By way of example, such test operations could involve attempting to provision an email source, destination, or user based upon an unrecognized IP address, etc. Moreover, the test operation could involve system diagnostics, as will be appreciated by those skilled in the art. If the email with the test indicator data added is to be sent after processing, then this data is removed prior to sending, concluding the illustrated method at Block 98. Otherwise, if no test indicator data is added by the inbound gateway server 36, then the email can be processed and sent in a normal fashion (Block 96).

Similar to the spam filtering processing described above, in accordance with another advantageous aspect now described with reference to FIG. 7 and beginning at Block 100, the supplemental processing data may also advantageously include viral (i.e., computer virus) vector data, at Block 102. Similar to the spam scoring data, viral vector data may also include criteria that indicates emails or attachments are potentially infected with viruses, as will be appreciated by those skilled in the art. If a viral vector is attached to an email (or the attached viral vector indicates a virus is likely present), at Block 103, the MUA server 37 can advantageously take the appropriate action, such as quarantine, deletion, etc., at Block 104. Otherwise, if a viral vector has been added which does not indicate the presence of a virus, then the viral vector data can be removed from the email following routine processing prior to sending, at Block 106, thus concluding the illustrated method (Block 108).

It should be noted that, depending upon the given embodiment, more than one of the above-described types of supplemental processing data may be used at a time. Of course, in some embodiments a single one of the supplemental processing data types may be used. Furthermore, other similar types of supplemental processing data may also be used in various embodiments, as will be appreciated by those skilled in the art. As will be described further below, the inbound and outbound gateway servers 36, 38 may advantageously be implemented using the IronPort® email security appliances noted above.

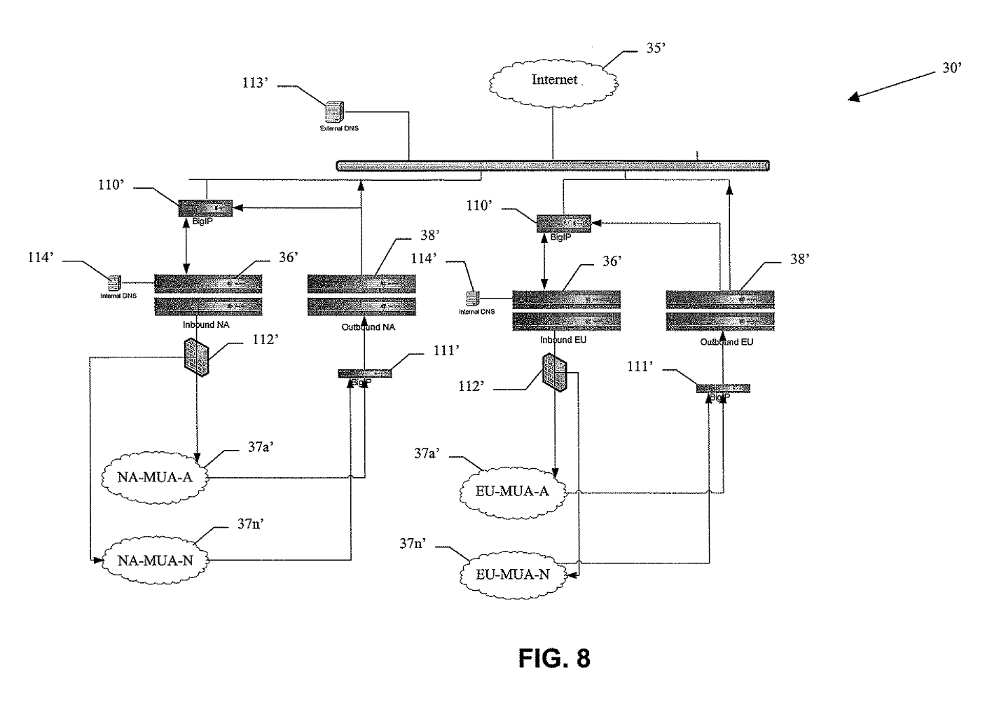

Turning now additionally to FIG. 8, an exemplary implementation of an email aggregation system 30′ with supplemental processing to provide anti-spam features is now described. The system 30′ advantageously provides a unified and consistent perimeter for all email aggregation, both incoming and outgoing, through the use of IronPort® C600 series appliances as the inbound and outbound gateway servers 36, 38. The system 30′ uses a common set of MUA servers 37 for incoming email (i.e., from wireless communications devices) by region, and a common set for outgoing email (i.e., to wireless communications devices) by region. By having a common entry point behind a load balancer (not shown), and applied uniformly, this may advantageously allow for a reduced set of public MX records, which helps keep DNS replies from being too long, as well as simplifying setups, as will be appreciated by those skilled in the art.

The IronPort® systems provide a very solid and stable Mail Gateway Appliance (MGA) platform that is capable of handling large amounts of both incoming and outgoing emails, along with an advanced domain queuing system, advanced deterministic mail routing capabilities, relatively simple management and substantially real-time reporting capabilities. The IronPort® units are located on a separate network VLAN from the MUA servers 37 so they are less likely to be affected by a service issue with other servers, although co-location is also possible.

The IronPort® C600/650 MGA provides a broad array of features and performance aspects that can be used in the system 30′. More particularly, the C600/650 provides a reputation based anti-spam system. This does not rely on content scanning or language heuristics, but uses a value obtained from the SenderBase® system and distributed via DNS, to gauge the apparent reputation of an IP and apply policies that can be dictated or selected appropriately. There is a Virus Outbreak Filter (VOF) system that also aids in spam and DDOS attacks by allowing for quick identification of emails that are propagated by or with a viral vector and stop them from penetrating the perimeter.

The C600/650 allows for advanced filtering options for mail routing and header manipulations. Any value in the email body or headers may be used to route mail to a specified MX or IP, add or remove headers, alter header content based on real-time values or provide notices and alerts. This also provides enhanced security on outbound email by stripping headers that reveal names and IPs of internal systems, for example, thus protecting proprietary infrastructure from potential attacks and/or discovery by competitors.

The C600/650 appliance also provides highly advanced queuing system beyond typical Sendmail or Postfix operations. Received and destination domains are managed as a separate virtual queue, with independent resource controls. This allows for consistent and timely email delivery for messages when one or more domains begin to present issues. For example, if several large volume destinations like GMAIL and Yahoo were to refuse out email for some reason, emails destined to MSN, AOL etc. would still go out with no impact. The queuing system would then try one email to each domain it has marked as down or faulty on a periodic basis until it can safely deliver it, then begin to ramp up delivery again as long as subsequent email is accepted.

The use of Virus Outbreak Filters (VOF) allow for enhanced security by allowing policies to be applied to emails that match threat-level signatures of viruses “in the wild.” This is an approach to protect the system 30′ from an outbreak of particular virus types that are rated as a high threat and do not have effective anti-virus (AV) measures in place yet. This will allow for an additional amount of protection against the propagation of viruses and spam that is a vector of a virus.

There is also real-time reporting in a Web-based GUI for the C600/650. At a glance the system load, traffic, throughput, email flow, SBRS (SenderBase Reputation Scores) of domains, and actions taken may be determined. The GUI allows an administrator to manage the policies and White/Blacklists for each system. The IronPort® appliance provides over 12 types of logs with varying information, all of which can be pushed on a regular basis to another server for parsing.

As noted above, IronPort® appliances have the ability to suppress the addition of a received header, as well as the ability to add or remove headers. The suppression and removal of headers is of particular use on the outgoing email pool to prevent knowledge of internal setup being sent in the headers. This includes information like internal server names, domains and IPs, for example, all of which reveal information that may preferably be kept private. On the incoming side the ability to add headers is used for spam, and may also be uses to identify test emails or add other headers based on rules and policies.

The IronPort® C600/650 appliance is a 2U device with dual-power, 3 NIC ports and a custom rail-and-cable management arm. The power supply cables terminate in a standard 3 prong 15 amp plug. The NIC ports are split into 2 data ports and one management port. The Data ports are Gigabit speed and support teamed failover. The management port for Out-Of-Band (OOB) is 100BaseTX.

In the exemplary embodiment, the C600/650 units are deployed onto a common network segment, and the C600/650s are the common entry and exit points for all emails to the system 30′. They will be accessed via inbound and outbound IP pool servers 110′, 111′ (“BigIP”) for each pool. The connections may be 100BaseTX for example, but can also be increased for greater capacity, such as to 100BaseTX, etc. Emails will come into the C600/650 and have appropriate policy decisions and actions applied, and then passed onto the corresponding systems mail servers. For example, and email can come into test@domain.com, be assessed as good and routed to the current incoming MUA servers. This advantageously allows for a common front end and flexibility in email architecture design and/or changes. The outbound side is treated in a similar fashion, with email being routed to the outgoing C6000/650 units and then handled appropriately at that point.

The data ports in the exemplary implementation are set up as teamed-failover ports, so one IP is needed and they will do layer 2 failover, similar to the method used by LFS (Linux) and Windows systems. The other port is for OOB management that supports the HTTPS GUI, CLI access and log push/pull via FTP/SCP/SFTP protocols. This allows the system 30′ to be accessed even when under a heavy load with email. It is also a safety measure as access to the box is restricted to an internal network segment for log and system management, and only DNS and MX requests need to be handled by the external facing interfaces.

Various numbers of inbound and outbound gateway servers 36′, 38′ may be used depending upon the given may volume encountered for a given region, etc., as will be readily appreciated by those skilled in the art. Moreover, different numbers of servers could be used for inbound and outbound emails again depending upon the inbound/outbound volumes, for example. However, the system 30′ advantageously allows for flexibility in increasing these numbers as needed depending on failover scenarios, geographic placements, etc.

The C600/650 units utilize the BigIP servers 110′ for connection load balancing. This advantageously allows all of the MUA servers 37′ to use the same DNS MX records for incoming email as well as outgoing email. For incoming emails, the C600/650 will accept the connections and apply any appropriate policies, then deliver the e-email (if warranted) to the MUA servers 37′ for the appropriate operation. This can be done with a static list of domain mappings or with the use of internal DNS. The use of internal DNS may advantageously avoid the need to maintain static lists on each C600/650 unit and facilitate deployments. The Internal DNS method would also allow the C600/650 to look up the MX record(s) for the domains it wishes to deliver to internally and send to the correct internal mail server. Message filters could also be used to use a portion of the domain, or a header to direct the email to the appropriate MUA servers 37′.

Outbound emails are handled in the same manner, with all MUA servers 37′ relaying their email to the outbound pool of C600/650 units. These would then send them to their final domains, including other MUA server 37′ domains, if appropriate, for further processing. These would be sent to the incoming C600/650 units as per any other incoming email, thus providing a seamless mail flow.

Each region also illustratively includes a virtual firewall 112′ setup on a same switch. One is for the inbound pool and the other is for the outbound pool. Each pool will be located behind a BigIP server 110′, 111′ for desired performance, load balancing and ease of maintenance. This may advantageously simplify the mail routes, as well as allow for the outbound pool to only need to query external DNS zones and reduce the need for internal DNS resolution or routes.

An external DNS server 113′ may be used for managing MX/A records, as well as the setup/modification of internal DNS systems. One or more external regional MX records may be used which may also be assigned an equal weighting. Internal DNS servers 114′ are used to route email to the appropriate MUA servers 37, after being assessed by the C600/650 units.

Various system events can be emailed to given email addresses (e.g., system administrator addresses). The alerts may be for hardware, software, virus out-break filters and anti-spam/virus components, for example, although other alerts could also be set, as will be appreciated by those skilled in the art. The C600/650 also has a set of SNMP alerts that can be used. In addition, the GUI allows for the inclusion of IPs and domain names for blocking as both explicit and wildcard entries. They can also be removed or altered from the same interface. The appropriate sender group is chosen and the IP or domain name is added to the list. Outgoing email can also be filtered against a list of addresses, either full or partial, that can be used to in the RCPT TO and MAIL FROM headers.

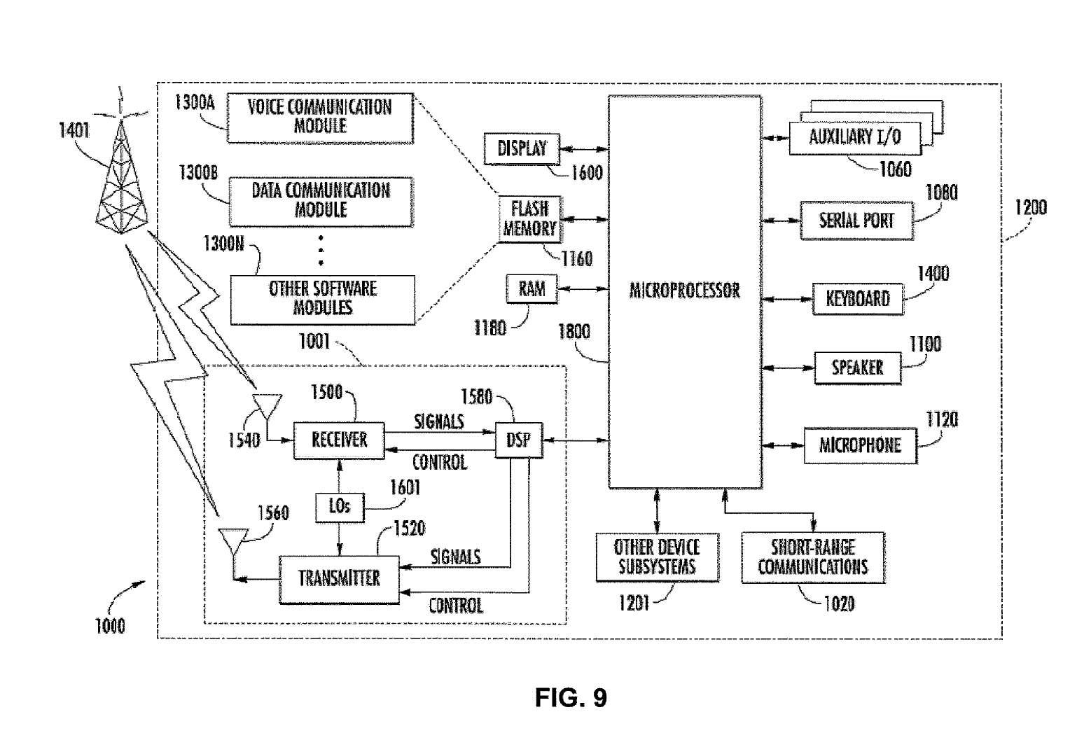

Exemplary components of a hand-held mobile wireless communications device 1000 that may be used in accordance with the systems 30, 30′ are further described in the example below with reference to FIG. 9. The device 1000 illustratively includes a housing 1200, a keypad 1400 and an output device 1600. The output device shown is a display 1600, which is preferably a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 9. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as email, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDNA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as email messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. An electronic mail (email) system comprising:
a plurality of mobile wireless communications devices;
a plurality of email storage servers; and
an email aggregation system operatively connected between said plurality of mobile wireless communications devices and said plurality of email storage servers for directing emails therebetween, said email aggregation system comprising
an inbound gateway server for receiving inbound emails and selectively adding supplemental processing data thereto,
at least one mail user agent (MUA) server downstream from said input gateway server for processing received emails based upon the selectively added supplemental processing data, and
an outbound gateway server downstream from said at least one MUA server for sending outbound emails after removing the supplemental processing data therefrom.

2. The email system of claim 1 wherein the supplemental processing data comprises spam sensitivity data.

3. The email system of claim 1 wherein said at least one MUA server comprises a plurality thereof; and wherein the supplemental processing data comprises supplemental routing data for routing emails to different MUA servers.

4. The email system of claim 3 wherein each MUA server has a respective IP address associated therewith; and wherein the supplemental routing data comprises an Internet Protocol (IP) address associated with a desired MUA server.

5. The email system of claim 1 wherein the supplemental processing data comprises mail exchange (MX) record data.

6. The email system of claim 1 wherein the supplemental processing data comprises email storage server identification data.

7. The email system of claim 1 wherein the supplemental processing data comprises test indicator data for causing the at least one MUA server to perform at least one test operation.

8. The email system of claim 1 wherein the supplemental processing data comprises viral vector data.

9. The email system of claim 1 wherein said wireless communications devices comprise cellular communications devices; and wherein said outbound gateway server sends email to said wireless communications devices via a cellular communications network.

10. An email aggregation system for directing emails between a plurality of mobile wireless communications devices and a plurality of email storage servers, the email aggregation system comprising:
an inbound gateway server for receiving inbound emails and selectively adding supplemental processing data thereto;
at least one mail user agent (MUA) server downstream from said inbound gateway server for processing received emails based upon the selectively added supplemental processing data; and
an outbound gateway server downstream from said at least one MUA server for sending outbound emails after removing the supplemental processing data therefrom.

11. The email aggregation system of claim 10 wherein the supplemental processing data comprises spam sensitivity data.

12. The email aggregation system of claim 10 wherein said at least one MUA server comprises a plurality thereof; and wherein the supplemental processing data comprises supplemental routing data for routing emails to different MUA servers.

13. The email aggregation system of claim 10 wherein the supplemental processing data comprises viral vector data.

14. An email aggregation system for directing emails between a plurality of mobile cellular communications devices and a plurality of email storage servers, the email aggregation system comprising:
an inbound gateway server for receiving inbound emails and selectively adding supplemental processing data thereto, the supplemental processing data comprising spam sensitivity data;
at least one mail user agent (MUA) server downstream from said inbound gateway server for processing received emails based upon the selectively added supplemental processing data; and
an outbound gateway server downstream from said at least one MUA server for sending outbound emails after removing the supplemental processing data therefrom.

15. The email aggregation system of claim 14 wherein said at least one MUA server comprises a plurality thereof; and wherein the supplemental processing data further comprises supplemental routing data for routing emails to different MUA servers.

16. The email aggregation system of claim 14 wherein the supplemental processing data further comprises viral vector data.

17. An email aggregation method for directing emails between a plurality of mobile cellular communications devices and a plurality of email storage servers and comprising:
receiving and selectively adding supplemental processing data to inbound emails at an inbound gateway server;
processing received emails at least one mail user agent (MUA) server downstream from the input gateway server based upon the selectively added supplemental processing data; and
removing the supplemental processing data from the processed received emails at an outbound gateway server downstream from the at least one MUA server prior to sending.

18. The method of claim 17 wherein the supplemental processing data comprises spam sensitivity data.

19. The method of claim 17 wherein the at least one MUA server comprises a plurality thereof; and wherein the supplemental processing data comprises supplemental routing data for routing emails to different MUA servers.

20. The method of claim 19 wherein each MUA server has a respective IP address associated therewith; and wherein the supplemental routing data comprises an Internet Protocol (IP) address associated with a desired MUA server.

21. The method of claim 17 wherein the supplemental processing data comprises mail exchange (MX) record data.

22. The method of claim 17 wherein the supplemental processing data comprises email storage server identification data.

23. The method of claim 17 wherein the supplemental processing data comprises test indicator data for causing the at least one MUA server to perform at least one test operation.

24. The method of claim 17 wherein the supplemental processing data comprises viral vector data.
